(19) United States
(12) Patent Application Publication
(10) Pub. No.: US 2026/0062960 A1
(43) Pub. Date: Mar. 5, 2026

(54) DOOR LOCK

(71) Applicant: Bo LIU, Zhuhai City (CN)

(72) Inventor: Bo LIU, Zhuhai City (CN)

(73) Assignee: HONG KONG QINGZHOU WANSHAN INDUSTRIAL CO., LIMITED, TSIM SHA TSUI (HK)

(21) Appl. No.: 19/383,795

(22) Filed: Nov. 10, 2025

(30) Foreign Application Priority Data
Oct. 23, 2025 (CN) 202522252409.9

(51) Int. Cl. E05B 57/00; E05B 15/04; E05B 37/02; E05B 53/00

(52) U.S. Cl. CPC E05B 57/00; E05B 37/02; E05B 53/003; E05B 2015/0448

(57) ABSTRACT

A door lock, including: a lock bolt, a lock catch assembly, a switching control assembly door lock, and a combination lock assembly. The lock bolt is fixedly connected to the inner side. The lock catch assembly includes a fastening state and a releasing state. When the door is closed, the lock catch assembly is in the fastening state, and the lock bolt is fastened by the lock catch assembly. When the door is closed, the switching control assembly switches the lock catch assembly from the fastening state to the releasing state, during a process of switching, the lock bolt automatically pops out of the lock catch assembly and drives the door to rotate to disengage from the closed state. The switching control assembly includes an unlocking state set to operable and a locking state that prohibits operation. The combination lock assembly controls the switching control assembly to switch.

### CROSS-REFERENCE TO RELATED APPLICATIONS

This application claims foreign priority of Chinese Patent application No. 202522252409.9, filed on Oct. 23, 2025 in the China National Intellectual Property Administration, the disclosures of all of which are hereby incorporated by reference.

### TECHNICAL FIELD

The present disclosure relates to the technical field of lock, in particular to a door lock that achieves a continuous action of “operation-unlock-pop open.”

### BACKGROUND

Traditional door locks have a long-standing core flaw in user experience and operational logic that has not been properly addressed: after the user unlocks the door from the outside mechanisms, the door cannot automatically pop open through the internal mechanisms of the lock and still requires the user to apply pushing or pulling force with the other hand to open it. This issue, referred to as the “one-handed freedom problem,” causes significant operational inconvenience and a fragmented experience in everyday scenarios such as carrying items or holding a baby. In addition, the operation method of the external mechanism (such as a knob, lever, etc.) has no direct connection with the final door-opening action in terms of direction and logic, which further increases the non-intuitiveness of operation.

In prior art, external lock control components are mostly rotational or pressure-based, with complex structures and inefficiency in force transmission. More importantly, these components often lack an intuitive operation method that provides clear feedback and smooth linear motion. Even when some solutions attempt to achieve unlocking from the outside of the door, the operating components and mounting housings usually have simple pivot or press-fit connections, which cannot achieve stable, smooth linear driving, affect the reliability and feel of the operation. Furthermore, such door locks generally lack effective locking mechanisms for the external switching control assembly, making it unreliable to prevent external component operation when needed (e.g., during indoor locking), thus creating security vulnerabilities.

To address the above issues, this disclosure aims to provide a door lock solution with a key improvement in the operation logic and structural form of the external side switching control assembly. By innovatively using an operating component slidably connected to the mounting housing, and having it directly drive the switching of the lock catch assembly's state through linear sliding relative to the mounting housing, the disclosure not only achieves intuitive and linear operation movements but also seamlessly connects a single-hand, single-slide operation to a continuous process of latch release, bolt popping, and automatic door opening. With a combination lock assembly that can lock this sliding operation, effectively solves the systemic deficiencies of traditional door locks in terms of operational intuitiveness, functional continuity, and security controllability.

### SUMMARY

To overcome the shortcomings of prior art, the present disclosure provides a door lock, by innovatively employing an operating component slidably connected to the mounting housing and driving the state switching of the lock catch assembly via linear sliding relative to the housing, not only realizes intuitive and linear operation but also seamlessly connects a single-hand, single-slide operation to a continuous process of latch release, bolt popping, and automatic door opening. This significantly improves the convenience, security, and overall user experience.

The technical solution adopted by the disclosure to solve the above problem is as follows.

A door lock, door lock, configured to lock or open a door, the door comprises an inner side, an outer side, and a mounting through hole passing through the inner side and the outer side, the door lock including: a lock bolt, which is fixedly connected to the inner side of the door, and the lock bolt is configured to rotate with a rotation of the door; and a lock catch assembly, which is fixedly connected to the inner side of the door, and the lock catch assembly comprises a fastening state and a releasing state; when the door is in a closed state, the lock catch assembly is in the fastening state, and the lock bolt is fastened by the lock catch assembly; and a switching control assembly, which is fixedly connected to the outer side of the door; when the door is in the closed state, the switching control assembly is configured for switching the lock catch assembly from the fastening state to the releasing state, and during a process of switching the lock catch assembly from the fastening state to the releasing state, the lock bolt automatically pops out of the lock catch assembly and drives the door to rotate to disengage from the closed state; the switching control assembly comprises an unlocking state set to operable and a locking state that set to prohibit operation; a combination lock assembly, which is configure to control the switching control assembly to switch between the unlocking state and the locking state.

The beneficial effects of the present invention are as follows. The door lock of the present disclosure achieves a balance between operational convenience and safety during use. The user can operate the external switching control assembly with one hand to trigger the release of the lock catch assembly. The lock bolt automatically pops out under the action of elastic potential energy, driving the door leaf to open, thereby completely solving the problem of traditional door locks requiring two-handed operation. This design is particularly suitable for scenarios such as holding items or carrying a baby.

Structurally, the coordinated interaction between the first elastic component and the movable element ensures smooth and reliable motion, reduces transmission complexity and failure rate, and extends the service life of the door lock. In terms of safety, the combination lock assembly controls the external operating state, effectively preventing unauthorized or accidental opening and enhancing the protective performance of the door lock.

### BRIEF DESCRIPTION OF DRAWINGS

In order to clearly explain the technical solutions in the embodiments of the present disclosure, the following will provide a brief description of the drawings in the embodiment description. The drawings below are only some embodiments of the present disclosure, and those skilled in the art can, without creative effort, derive other drawings from these. Furthermore, the drawings are not scaled to a 1:1 ratio, and the relative sizes of the components in the drawings are only depicted for illustration, not necessarily to scale.

The disclosure will be further described in conjunction with the drawings and embodiments as follows.

FIG. 1 is a schematic structural diagram of a door lock from a first angle according to an embodiment of the present disclosure.

FIG. 2 is a schematic structural diagram of the door lock from a second angle according to an embodiment of the present disclosure.

FIG. 3 is an exploded view of the door lock of FIG. 1.

FIG. 4 is an exploded view of the door lock of FIG. 2.

FIG. 5 is a first exploded diagram of a lock catch assembly of the door lock.

FIG. 6 is a second exploded diagram of the lock catch assembly of the door lock.

FIG. 7 is a partial schematic structural diagram showing the first abutting portion (including the first abutting position, second abutting position, and unlocking position) and the second abutting portion in mutual contact without external force.

FIG. 8 is an enlarged schematic diagram of a partial of the door lock according to an embodiment of the present disclosure.

FIG. 9 is an exploded diagram of a switching control assembly of the door lock.

FIG. 10 is an exploded diagram of a combination lock assembly of the door lock

FIG. 11 is a schematic structural diagram of a door according to an embodiment of the present disclosure.

FIG. 12 is a schematic structural diagram of a door lock installed on the door from a first angle, showing a first abutting portion in a first abutting position, and a second abutting portion is in mutual contact without external force.

FIG. 13 is an installation schematic diagram of the door lock, showing the operating component 330 slides upward to control the locking component 200.

FIG. 14 is a schematic structural diagram of the door lock installed on the door from the first angle, showing a first abutting portion in a second abutting position, and a second abutting portion is in mutual contact without external force.

FIG. 15 is a schematic structural diagram of a door lock installed on the door from a first angle, showing the first abutting portion in the unlocking position, and the second abutting portion is in mutual contact without external force.

FIG. 16 is an enlarged view of an area A in FIG. 12.

FIG. 17 is an enlarged view of an area B in FIG. 14.

FIG. 18 is an enlarged view of an area C in FIG. 15.

FIG. 19 is an installation schematic diagram of the door lock, showing the operating component slides downward to control the locking component 200;

FIG. 20 is installation schematic diagram of the door lock, showing the operating component slides diagonally upwards to control the locking component 200

### DESCRIPTION OF THE REFERENCE NUMERAL

100 lock bolt, 200 lock catch assembly, 300 switching control assembly, 400 combination lock assembly, 110 locking rod, 120 handle, 130 fixing seat, 210 fixing component, 211 outer housing, 2111 housing body, 2111a guiding groove, 2111b button mounting hole, 2112 housing cover, 212 inner housing, 2121 first installing shaft, 2122 second installing shaft, 2123 matching portion, 2124 limiting portion, 213 accommodating space, 220 active component, 221 buckling component, 2211 first preload abutting portion, 2212 first abutting portion, 2212a first fastening position, 2212b second fastening position, 2212c unlocking position, 2213 locking portion, 2214 third abutting portion, 222 control component, 2221 second preload abutting portion, 2222 second abutting portion, 2223 triggering portion, 2223a connecting through hole, 230 first elastic component, 240 control button, 241 guiding rib, 310 flexible traction component, 311 first connecting end, 312 second connecting end, 320 mounting base, 330 operating component, 331 mounting hole, 332 first sliding connection portion, 333 extending component, 34 mounting housing, 341 second sliding connection portion, 350 mounting cover, 410 locking frame, 411 locking block, 420 codon component, 421 second elastic component, 422 driving component, 423 password wheel, 424 password changing button, 10 door, 11 inner side, 12 outer side, 13 mounting through hole.

### DETAILED DESCRIPTION OF THE EMBODIMENTS

To make the objectives, features, and advantages of the present disclosure more obvious and easier to understand, the following provides a detailed explanation of the specific embodiments of this disclosure in conjunction with the accompanying drawings. In the following description, many specific details are given to facilitate a full understanding of the disclosure.

However, the disclosure can be implemented in many different ways other than those described herein, and those skilled in the art can make similar improvements without departing from the scope of this disclosure. Therefore, the disclosure is not limited to the specific embodiments disclosed below.

In the description of this disclosure, it should be understood that if terms such as “center,” “longitudinal,” “lateral,” “length,” “width,” “thickness,” “up,” “down,” “front,” “back,” “left,” “right,” “vertical,” “horizontal,” “top,” “bottom,” “inside,” “outside,” “clockwise,” “counterclockwise,” “axial,” “radial,” and “circumferential” appear, the orientations or positional relationships indicated by these terms are based on the orientations or positional relationships shown in the drawings, for convenience of description, and are not meant to indicate or imply that the devices or components referred to must have specific orientations or be constructed and operated in specific orientations. Therefore, they should not be understood as limiting the scope of the disclosure.

Moreover, if terms such as “first” and “second” appear, these terms are used merely for descriptive purposes and should not be understood to indicate or imply relative importance or imply the number of technical features indicated. Thus, features labeled “first” or “second” may explicitly or implicitly include at least one such feature. In this disclosure, the term “multiple” means at least two, such as two, three, etc., unless otherwise explicitly defined.

In this disclosure, unless otherwise clearly stated, if terms like “mounted,” “connected,” “attached,” or “fixed” are used, these terms should be understood in a broad sense. For example, it could mean fixed connection, removable connection, or integrated; it could be mechanical connection or electrical connection; it could be a direct connection or an indirect connection via an intermediary; it could refer to the internal connection of two components or the interaction between two components, unless explicitly limited. Those skilled in the art can understand the specific meanings of these terms based on the context.

In this disclosure, unless otherwise clearly stated, when the first feature is described as being “on,” “above,” or “below” a second feature, it can mean that the first and second features are in direct contact or indirectly in contact through an intermediate medium. Also, when the first feature is described as being “on,” “above,” or “on top of” the second feature, it may mean that the first feature is directly above or obliquely above the second feature, or it may simply indicate that the first feature is at a higher horizontal level than the second feature. Similarly, when the first feature is described as being “below,” “beneath,” or “underneath” the second feature, it may mean that the first feature is directly below or obliquely below the second feature, or it may simply indicate that the first feature is at a lower horizontal level than the second feature.

It should be noted that if a component is described as being “fixed to” or “arranged on” another component, it may be directly on the other component or may be positioned through a centered component. If one component is described as “connected” to another component, it may be directly connected to the other component or may involve an intermediate component. The terms “vertical,” “horizontal,” “up,” “down,” “left,” “right,” and similar expressions used in this disclosure are for illustrative purposes only and do not represent the only possible implementation.

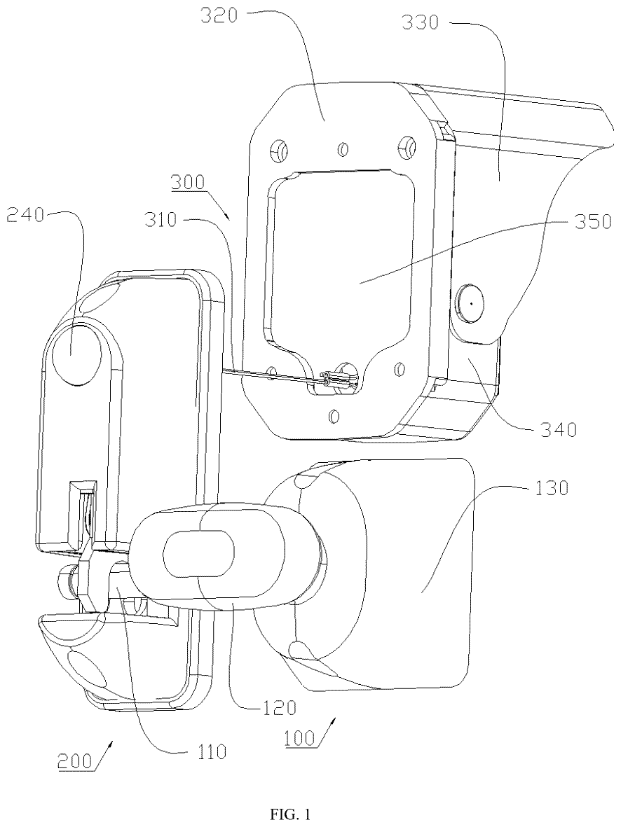

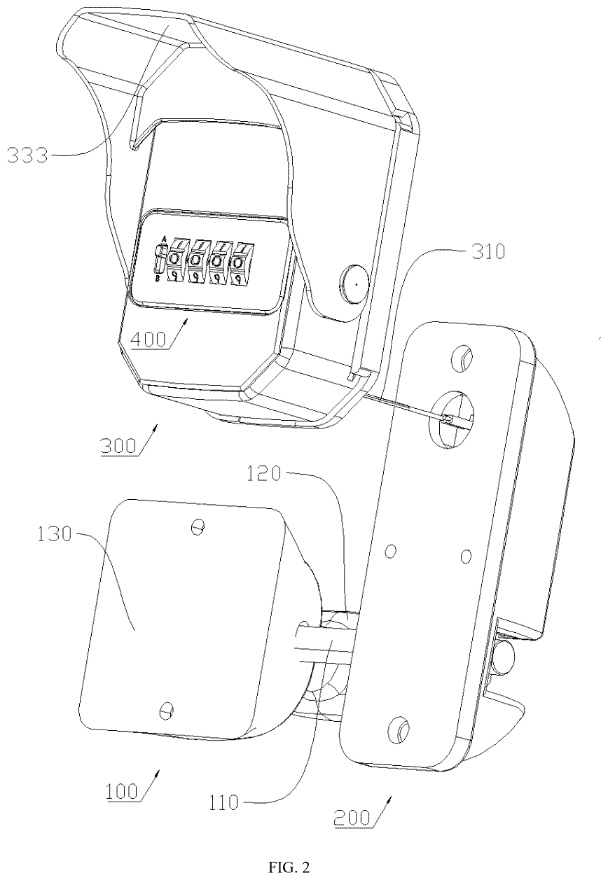

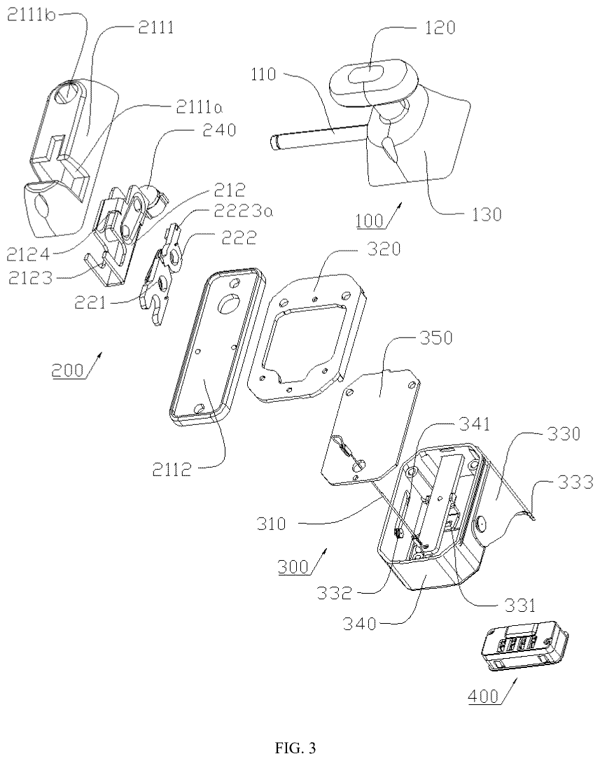

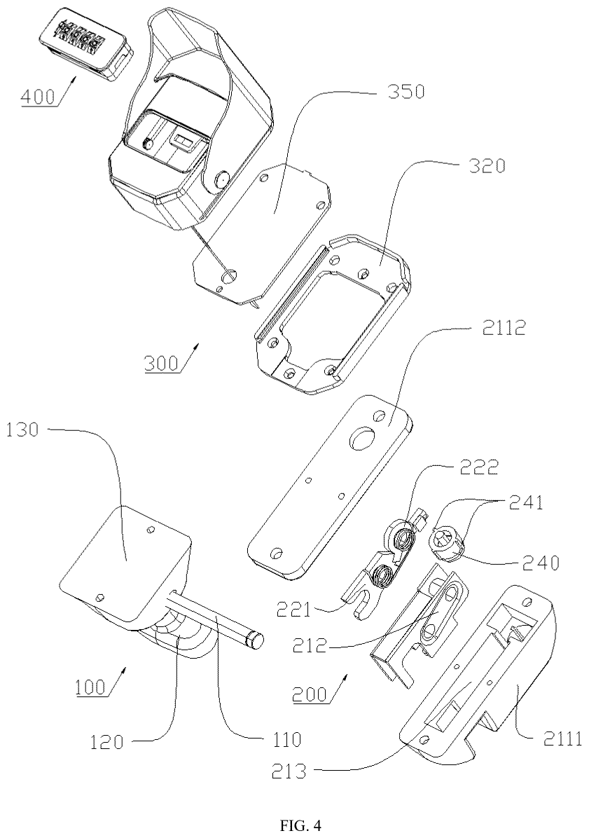

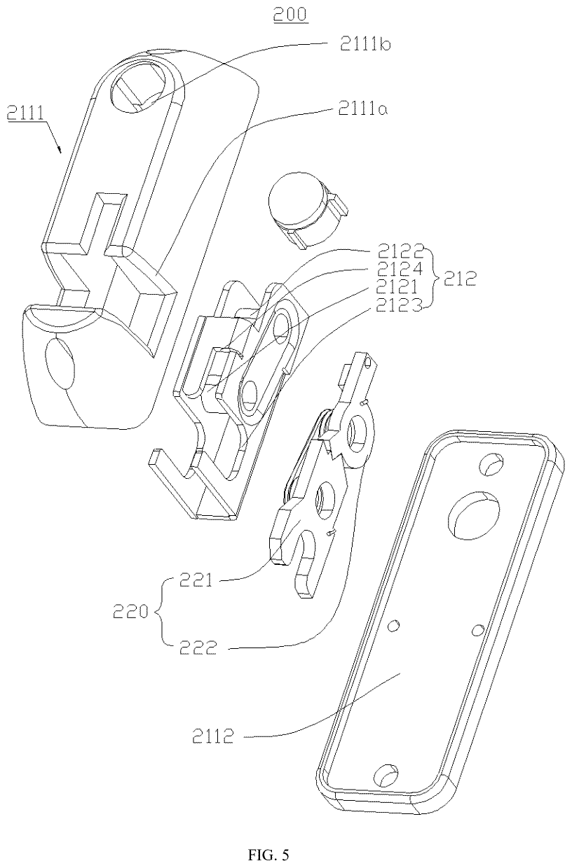

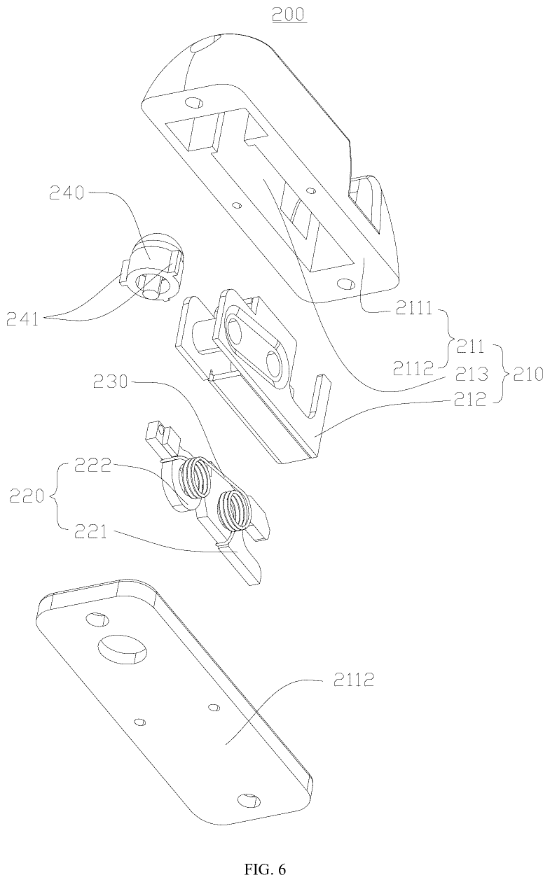

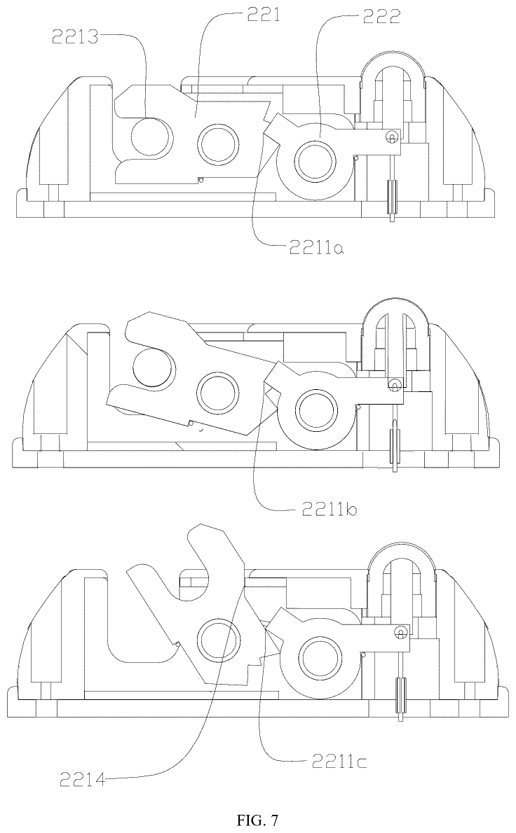

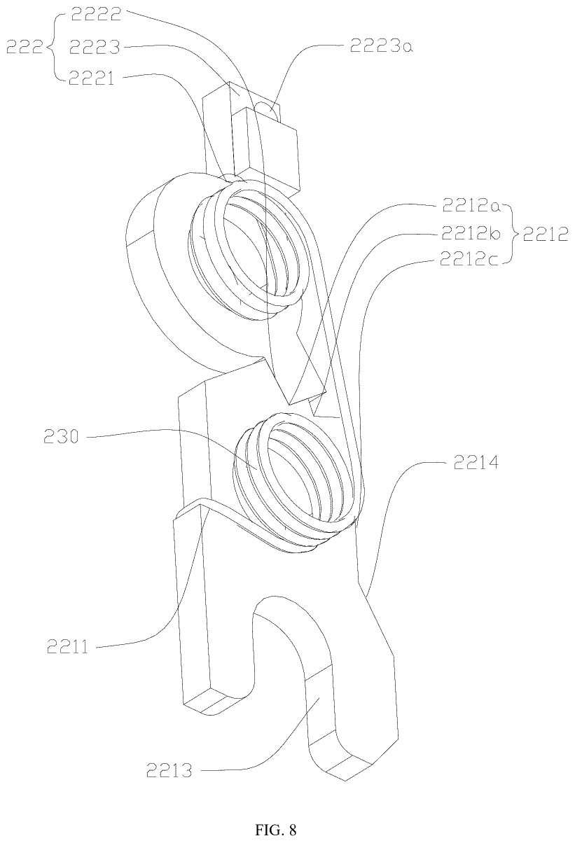

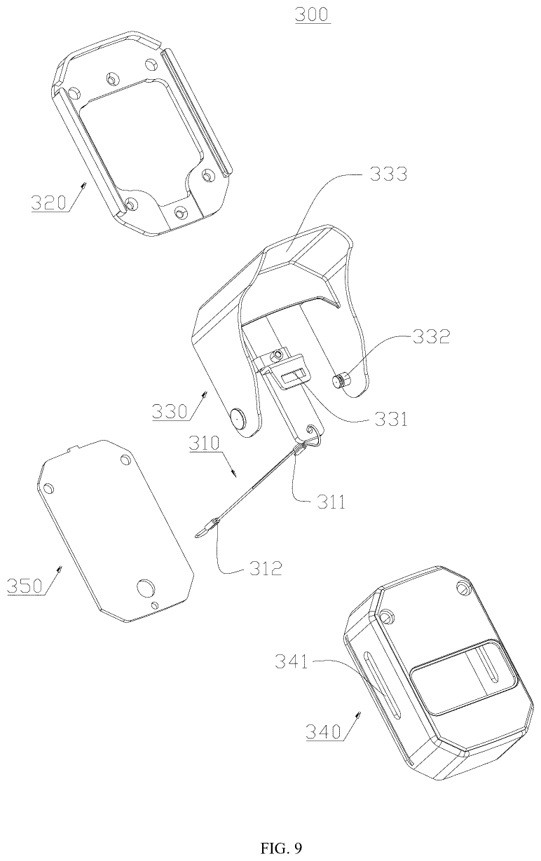

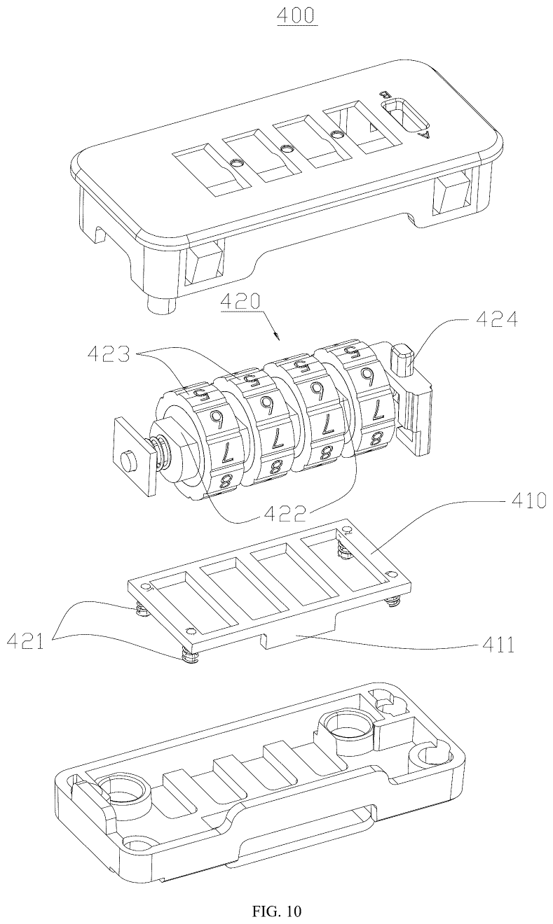

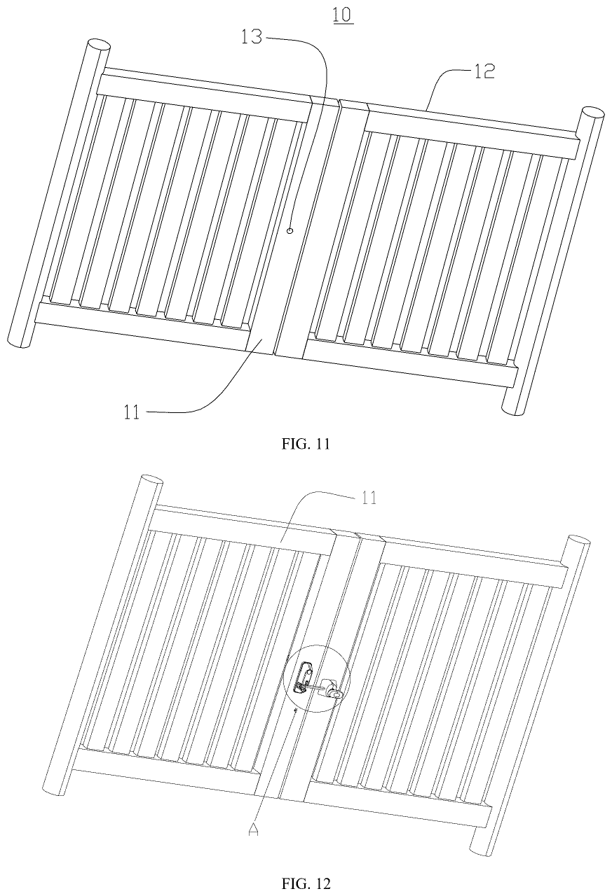

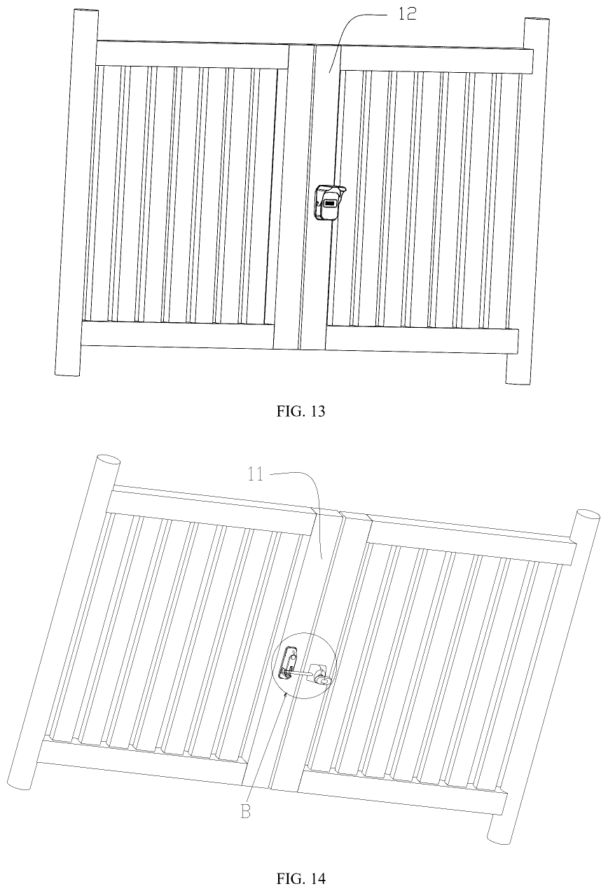

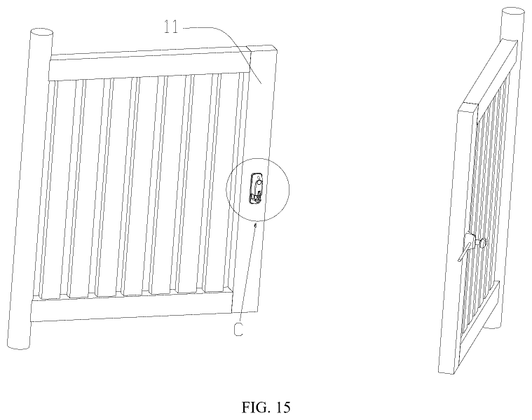

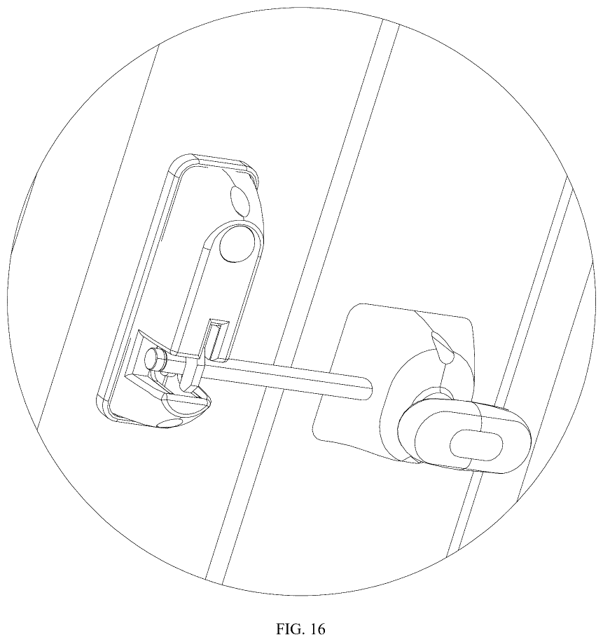

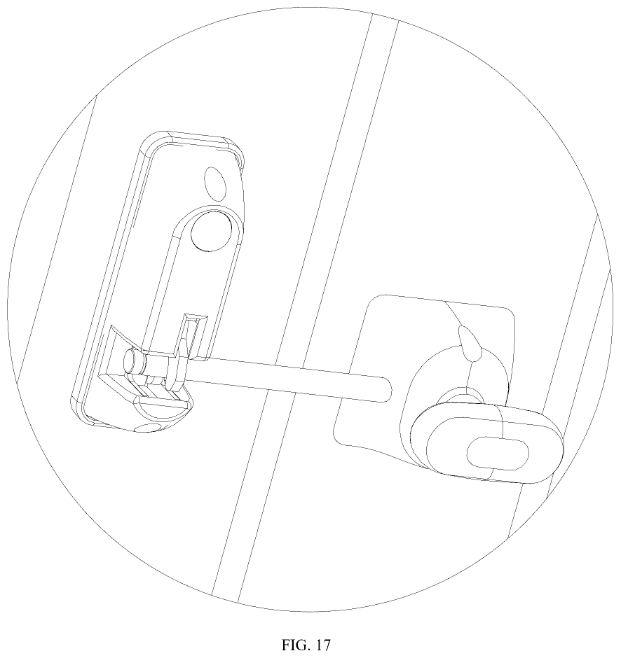

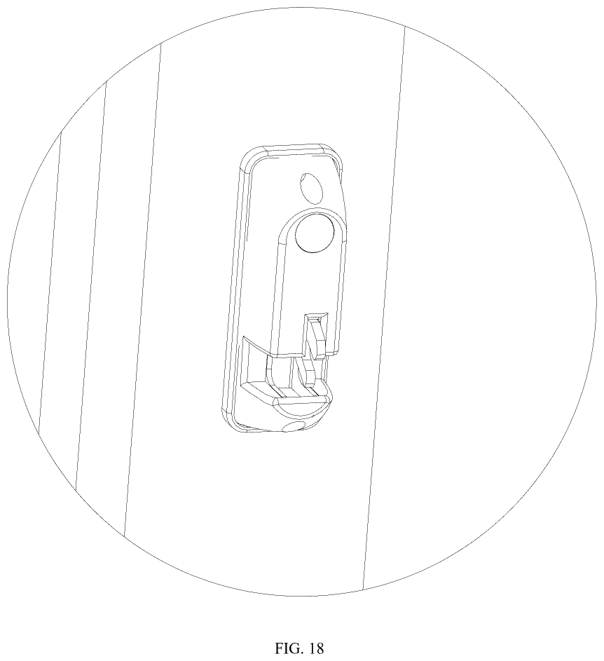

Referring to FIGS. 1 to 20, a door lock for locking or unlocking a door 10, the door 10 includes an inner side 11, an outer side 12, and a mounting through hole 13 passing through both the inner side 11 and the outer side 12. The door lock includes: a lock bolt 100, a lock catch assembly 200, switching control assembly 300 and a combination lock assembly 400.

The lock bolt 100 is fixedly connected to the inner side 11 of the door 10 and configured to rotate with the rotation of door 10.

The lock catch assembly 200 is fixedly connected to the inner side 11 of door 10. The lock catch assembly 200 includes a fastening state and a releasing state. When door 10 is in the closed state, the lock catch assembly 200 is in the fastening state, and the lock bolt 100 is fastened by the lock catch assembly 200.

The switching control assembly 300 is fixedly connected to the outer side 12 of door 10. When the door 10 is in the closed state, the switching control assembly 300 switches the lock catch assembly 200 from the fastening state to the releasing state. During a process of the lock catch assembly 200 switching from the fastening state to the releasing state, the lock bolt 100 automatically pops out of the lock catch assembly 200 and drives the door 10 to rotate and disengage from the closed state. The switching control assembly 300 has an unlocking state set to operable and a locking state that set to prohibit operation.

The combination lock assembly 400 is configure to control the switching control assembly 300 to switch between the unlocking state and the locking state.

Through the above structures, the user only needs to operate the switching control assembly 300 on the outer side 12 of door 10 to trigger a coherent automatic process: the lock catch assembly 200 state switching→the lock bolt 100 automatically popping out→the door 10 opening with rotational thrust. This completely resolves the pain point of traditional door locks requiring “one hand to unlock, and the other to push the door,” greatly enhancing convenience, especially in daily life scenarios such as carrying items or holding a baby. The mechanical structures (such as flexible traction component) link the components on the inner side 11 and outer side 12 of the door 10. An external force on the outer side 12 of the door 10 is accurately transmitted to the inner side 11 of the door 10. Through the internal mechanisms of the lock catch assembly 200 (such as elastic component), stored energy is released to convert into the power to push the lock bolt 100 out. This design is clear in action, responsive, and reliable, reducing failure points. When the door 10 is closed, the lock catch assembly 200 automatically enters and maintains the fastening state, securely holding the lock bolt 100. This provides reliable locking force, effectively preventing accidental opening of the door due to wind, vibration, or impact, ensuring safety and privacy. The entire operation process is intuitive: a single action outside the door completes the opening. Users clearly perceive the feedback on the completion of the operation (e.g., hearing the lock bolt pop out, seeing the door begin to rotate), making the interaction simple and clear.

At the same time, the door lock typically requires specific and intentional operations to unlock, preventing safety risks that may arise from accidental misuse. In this embodiment, the combination lock assembly 400 further enhances security and controllability: by switching the switching control assembly 300 to a locking state that prohibits operation, it effectively prevents unauthorized opening from the outer side 12 of the door 10, meeting higher security requirements in different scenarios. The locking function is independent from the convenient unlocking process, ensuring that the door lock provides reliable locking protection when needed, while maintaining convenience for everyday use. The overall structure achieves internal and external coordination through mechanical linkage, with clear actions and fast responses, making the door lock system a balance between the convenience of automatic opening and the proactive, controllable security.

In this embodiment, the lock catch assembly 200 includes a fixing component 210, an active component 220, and a first elastic component 230. The fixing component 210 is fixedly connected to the inner side 11 of door 10, and the active component 220 is rotatably connected to the fixing component 210. The active component 220 includes a fastening state and a releasing state, and during the process of the active component 220 switching from the fastening state to the releasing state, the first elastic component 230 applies elastic force to the lock bolt 100 via the active component 220, causing the lock bolt 100 to automatically pop out of the lock catch assembly 200 and drive the door 10 to rotate and disengage from the closed state.

With the above structures, during use, the energy storage of the first elastic component 230 does not come from the user's operation when opening the door, but is automatically completed during the door closing process. The user's operation on the outer side 12 of the door 10 merely serves as a trigger signal to release the energy that has been previously stored. This greatly simplifies the amount of effort required by the user to open the door, achieving true “effort-saving.” The user only needs a very light trigger force (such as a pull force) to release the larger energy stored during the door closing process, causing the door to pop and open, creating a very light and efficient experience.

It is important to note that in this embodiment, the actions of “energy storage” and “energy release” are completely separated in time. Since the elastic energy comes from the natural action of closing the door, the amount of energy stored (i.e., a degree of twisting of the first elastic component 230) is determined by the door's closed state, providing a consistent energy reserve with every door closing. This ensures that the force and effect of automatic door opening are stable and reliable, regardless of how fast or slow the user operates the door or how much force is applied, ensuring effective automatic door opening and avoiding situations where improper operation leads to insufficient opening force or failure. The energy storage process, which involves high intensity and large travel, is combined with the natural action of closing the door, while the trigger action, which involves light force and small travel, is left to the opening operation. This design rationally distributes the mechanical stress conditions of the components. The components responsible for most of the energy storage (such as the first elastic component 230) experience slow and single-force loads, while the outer door operation components (such as handles or buttons) only bear a very small triggering force. This extends the lifespan of all components and makes the force flow design of the entire system more scientific and durable.

In summary, the core function of this technical solution is no longer simply to “use the first elastic component to pop the door open,” but rather to cleverly separate the actions of “closing the door for energy storage-operating for energy release,” achieving the most stable and powerful automatic door opening effect with minimal user operation cost, while achieving excellent levels of structural reliability and user experience.

In this embodiment, the fixing component 210 includes an outer housing 211 and an inner housing 212. The outer housing 211 is fixedly connected to the inner side 11 of the door 10 and defined with an accommodating space 213. The inner housing 212 is located inside the accommodating space 213, and the active component 220 is rotatably connected to the inner housing 212.

With the above structures, during use, the outer housing 211, as the first protective barrier directly mounted on the outer side 12 of the door 10, effectively protects the internal components, such as the inner housing 212 and active component 220, from dust, foreign objects, or human damage, improving the durability and reliability of the product. The inner housing 212, as an independent structure, is pre-assembled with the active component 220 and other components and then inserted into the accommodating space 213 of the outer housing 211. This greatly simplifies the on-site installation and subsequent maintenance process, improving production and installation efficiency. The inner housing 212 provides a solid and precise mounting base for the rotation of the active component 220, ensuring the accuracy and consistency of the movement trajectory of the active component 220, thereby ensuring the reliable execution of the locking and releasing actions. The outer housing 211 is composed of the housing body 2111 and the housing cover 2112, the housing body 2111 is defined with a guiding groove 2111a and a button mounting hole 2111b.

In this embodiment, the inner housing 212 has a first installing shaft 2121 and a second installing shaft 2122. The active component 220 includes a buckling component 221 and a control component 222. The buckling component 221 is rotatably connected to the first installing shaft 2121, and the control component 222 is rotatably connected to the second installing shaft 2122. The first elastic component 230 abuts against the buckling component 221 and the control component 222 to ensure that the buckling component 221 and the control component 222 are in mutual contact without external force.

Through the above structures, during use, by subdividing the active component 220 into the buckling component 221 and the control component 222, and mounting them on a first installing shaft 2121 and a second installing shaft 2122 respectively, the locking function (performed by the buckling component 221) is separated from the control and triggering function (performed by the control component 222). These two functions are coupled through the preloading force of the first elastic component 230, allowing a light operational force on the outer side of the door (acting on the control component 222) to reliably trigger a strong lock release action inside the door (performed by the buckling component 221), achieving an “effort-saving” effect. The first elastic component 230 continuously applies a preloading force to the buckling component 221 and the control component 222, forcing them into mutual contact. This component 221 has a first preload abutting portion 2211 and a first abutting portion 2212. The control component 222 has a second preload abutting portion 2221 and a second abutting portion 2222. The first elastic component 230 abuts against the first preload abutting portion 2211 and the second preload abutting portion 2221 and applies an elastic preloading force to them, ensuring that the first abutting portion 2212 and the second abutting portion 2222 are in mutual contact in the absence of external forces.

Through the above structures, during use, by setting the first preload abutting portion 2211 and the second preload abutting portion 2221 to precisely receive the preloading force of the first elastic component 230, and using the mutual contact between the first abutting portion 2212 and the second abutting portion 2222 to transmit movement and maintain the state, the core function is: to optimize the transmission path of the elastic preloading force, ensuring the precise and stable interrelationship between the buckling component 221 and the control component 222, thus allowing a light operational force outside the door to reliably trigger the strong release of the lock bolt inside the door, achieving an effort-saving and reliable one-handed automatic door opening.

In this embodiment, the buckling component 221 is further provided with a locking portion 2213, and the inner housing 212 is further provided with a matching portion 2123. The first abutting portion 2212 includes a first fastening position 2212a, a second fastening position 2212b, and an unlocking position 2212c. When the first abutting portion 2212 and the second abutting portion 2222 are respectively abutting at the first fastening position 2212a and the second fastening position 2212b, the matching portion 2123 is coupled with the locking portion 2213, thereby fastening the lock bolt 100 between the matching portion 2123 and the locking portion 2213, making the lock catch assembly 200 in the fastening state. When the first abutting portion 2212 and the second abutting portion 2222 are abutting at the unlocking position 2212c, the matching portion 2123 and the locking portion 2213 decouple, causing the lock bolt 100 to automatically pop out from between the matching portion 2123 and the locking portion 2213, thereby making the lock catch assembly 200 in the releasing state. Through these structures, the coupling and decoupling mechanism of the locking portion 2213 and the matching portion 2123, along with the multiple precise positioning points of the first abutting portion 2212, creates a stable, reliable, and fault-tolerant bistable locking structure. Particularly, the setting of the second fastening position 2212b enables it to effectively adapt to misalignment and uneven conditions that may occur when the fence door closes, ensuring that under non-ideal conditions, the lock catch assembly 200 can still securely fasten the lock bolt 100, and instantly decouple and release upon triggering, reliably and automatically popping open the door leaf. This greatly enhances the product's adaptability and reliability in practical applications.

In this embodiment, the buckling component 221 is further provided with a third abutting portion 2214, and the control component 222 is further provided with a triggering portion 2223. The inner housing 212 is also provided with a limiting portion 2124. When the triggering portion 2223 is acted upon by an external force, the control component 222 overcomes the elastic preloading force provided by the first elastic component 230 and rotates until it is no longer in an abutting state with the first abutting portion 2212, at which point the limiting portion 2124 abuts against the third abutting portion 2214, and the lock catch assembly 200 is in the releasing state. At this moment, if the external force is removed, the first abutting portion 2212 and the second abutting portion 2222, driven by the elastic preloading force, remain in abutment at the unlocking position 2212c. Through these structures, by setting up the third abutting portion 2214, the triggering portion 2223, and the limiting portion 2124 in coordination, not only is the release state stably maintained, but more importantly, during the subsequent door closing process, this coordination mechanism automatically and reliably guides the buckling component 221 and the control component 222 to recouple and lock in the first fastening position 2212a or the second fastening position 2212b, thereby allowing the first elastic component 230 to complete energy storage, preparing for the next automatic popping open of the door, realizing the cycle automation from “release” to “recharging.”

In this embodiment, the switching control assembly 300 includes a flexible traction component 310, a mounting base 320, and an operating component 330. The operating component 330 is movably connected to the mounting base 320, and the mounting base 320 is fixedly connected to the outer side 12 of the door 10. The triggering portion 2223 is provided with a connecting through hole 2223a. The flexible traction component 310 includes a first connecting end 311 and a second connecting end 312. The second connecting end 312 is connected to the triggering portion 2223 through the connecting through hole 2223a, and the first connecting end 311 passes through the mounting hole 13 and connects to the operating component 330. By pulling the flexible traction component 310 and the triggering portion 2223 through the operating component 330, the control component 222 overcomes the elastic preloading force provided by the first elastic component 230 and rotates, until it is no longer in an abutting state with the first abutting portion 2212, and ultimately switches the lock catch assembly 200 from the fastening state to the releasing state. During this process of the lock catch assembly 200 transitioning from the fastening state to the releasing state, the matching portion 2123 and the locking portion 2213 decouple, and under the action of the elastic preloading force provided by the first elastic component 230, the lock bolt 100 automatically pops out from between the matching portion 2123 and the locking portion 2213, and drives the door 10 to rotate and detach from the closed state.

The switching control assembly 300 also includes a mounting cover 350, which is fixedly connected to the mounting housing 340 via a threaded fastener.

With the above structures, during use, the switching control assembly 300 achieves efficient linkage between the outside door operation and the inside lock release through the cooperative arrangement of the flexible traction component 310, the mounting base 320, the operating component 330, and the mounting housing 340. The user applies a light pulling force to the operating component 330, which is accurately transmitted to the control component 222 through the flexible traction component 310, triggering the control component 222 to overcome the elastic preload and rotate, thereby disengaging from the engaging component 221 and switching the lock mechanism from a locked to an unlocking state. Subsequently, the preload force of the first elastic component 230 drives the locking portion 2213 to decouple from the matching part 2123, pushing the locking bolt 100 to automatically pop out and driving the door 10 to rotate open.

The beneficial effects of above structures are significant. First, it provides a “single action, automatic door opening” experience, where the user does not need to push the door, especially suitable for scenarios like carrying items with both hands. Second, the flexible traction component 310 ensures that the force applied from the outside of the door is transmitted efficiently and reliably to the internal mechanism, with a quick and effortless response. Lastly, the entire mechanism is simple, with clear actions, reducing potential failure points, improving the durability and consistency of the locking system, and laying the foundation for future integration of the locking function, balancing automatic opening with security and control.

It should be noted that the mounting base 320 is hollowed out to save materials, and additional middle mounting holes are provided near the upper and lower edges of the mounting base 320 (normally side mounting holes are only placed near the left and right sides of the upper and lower edges), allowing the mounting base 320 to be securely fixed to the outer side 12 of the door 10 through either the left or right side mounting holes and the middle mounting holes when the installation space is relatively narrow. The mounting housing 340 is equipped with a mounting rail, while the mounting base 320 has a mounting slot. After the mounting housing 340 and mounting base 320 are connected by sliding through the installation rail and slot, they are fixedly connected to the outer side 12 of the door 10 with threaded fasteners.

In this embodiment, the combination lock assembly 400 includes a locking frame 410, which is configured to selectively limit the movement of the operating component 330, allowing the operating component 330 to switch between the unlocking state of the switching control assembly 300 and the locking state, thereby prohibiting the operation.

With the above structure, during use, the combination lock assembly 400, by setting the locking frame 410, can selectively limit the movement of the operating component 330, adding an active safety control layer to the locking system. By switching the operating component 330 between the “unlocking state that allows operation” and the “locking state that prohibiting operation” it effectively prevents unauthorized or accidental unlocking from the outside of the door, ensuring convenient daily use while meeting higher security and privacy requirements in specific scenarios, thus enhancing the overall controllability and safety of the locking system.

In this embodiment, the locking frame 410 is equipped with a locking block 411, and the operating component 330 is equip with an operating portion 331 that cooperates with the locking block 411. When the locking block 411 engages with the operating portion 331, the operating component 330 is in the locking state. When the locking block 411 is separated from the operating portion 331, the operating component 330 is in the unlocking state.

Through the above structures, the locking and unlocking of the operating component 330 is mechanically interlocked via the engagement and separation of the locking block 411 and operating portion 331, ensuring smooth operation in the unlocking state. When engaged, the movement of the operating component 330 is effectively limited, forming a reliable locking state to prevent unauthorized operation. When separated, the restriction on the movement of the operating component 330 is lifted, ensuring smooth unlocking. This mechanical interlock structure is clear and reliable, providing users with clear feedback on the lock/unlock status, greatly enhancing the door lock's resistance to tampering and overall security in the locking state.

In this embodiment, the combination lock assembly 400 also includes a password component 420, which is operatively connected to the locking frame 410 and is configured to allow the locking frame 410 to move when the correct password is input, thus separating the locking block 411 from the operating portion 331.

With the above structures, by introducing the password component 420 and linking it to the locking frame 410, an additional layer of verifiable permission management is added to the locking system. The user must input the correct password to activate the movement of the locking frame 410, thus removing the restriction on the operating component 330. This greatly enhances the security level of the lock, effectively preventing unauthorized unlocking through mechanical means (such as prying or key duplication), while providing the convenience of not needing a physical key. It integrates security with convenience.

The password component 420 includes a second elastic component 421 that provides preload force to the locking frame 410, making the locking block 411 tend to separate from the operating portion 331 (in this embodiment, a spring), a driving component 422 that provides driving force to the locking frame 410, enabling the locking block 411 to overcome the preload force and engage with the operating portion 331, and a password wheel 423 that provides verification for driving the driving component 422. When the correct password is entered into the password wheel 423, the locking frame 410 can remove the movement restriction on the operating component 330. The password component also includes a password changing button 424 for easily changing the password when the password changing button 424 is turned on.

In this embodiment, the operating component 330 also provided with a first sliding connection portion 332, and the mounting housing 340 is provided with a second sliding connection portion 341. The operating component 330 and mounting housing 340 are slidably connected through the first sliding connection portion 332 and the second sliding connection portion 341.

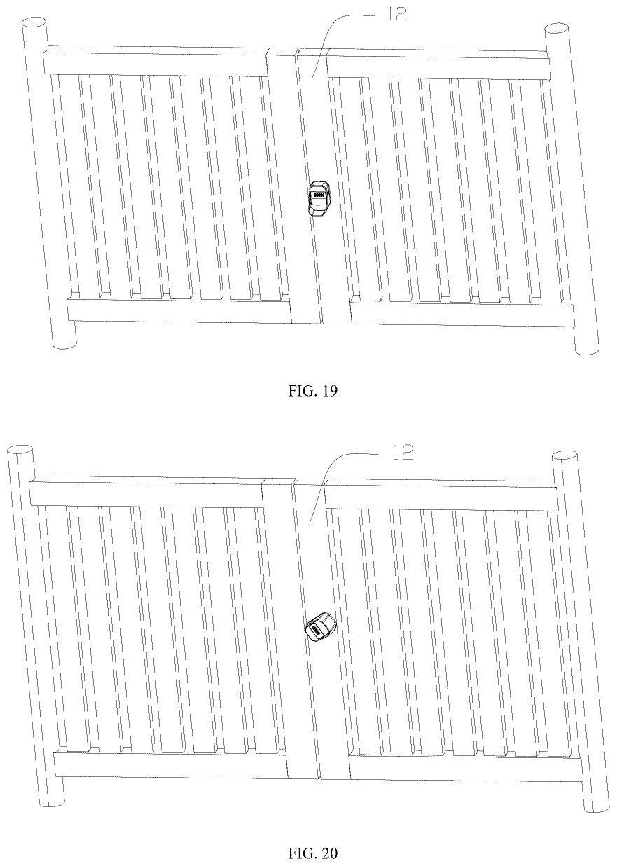

With the above structures, during use, the first sliding connection portion 332 and the second sliding connection portion 341 cooperate to enable linear motion of the operating component 330 relative to the mounting housing 340 in a roughly vertical direction, providing a stable, smooth, and clearly guided movement path for the operating component (such as a button or handle). On the one hand, this ensures that the user's operation force is efficiently and accurately transmitted to the flexible traction component, improving the sensitivity and reliability of unlocking response. On the other hand, this sliding connection structure enhances the mechanical stability of the components, reducing wear and jamming caused by wobbling or misalignment. It should be noted that in the preferred embodiment, the operating component 330 is operated in a generally vertical direction, but it does not necessarily mean it can only be operated in this direction. The operating component 330 can also be operated in other directions (for example, as shown in FIGS. 19 and 20, the operating component 330 can be oriented differently during installation).

In this embodiment, the operating component 330 also has an extending portion 333 for facilitating user operation. The extending portion 333 is located above the switching control assembly 300 and extends in the direction away from the extending portion 333. This design provides a clear and effortless operation point for the user, while also serving the auxiliary functions of wind and rain protection and preventing external peeking. In the unlocking state, the user only needs to apply an upward force to the extending portion 333, triggering the door leaf to automatically pop open, making the door-opening operation more intuitive, convenient, and reliable.

In this embodiment, the lock bolt 100 includes a locking rod 110, a handle 120, and a fixing seat 130. With this modular design, the lock bolt 100 integrates functionality and structural optimization: the locking rod 110 directly engages with the locking mechanism to ensure secure locking; the handle 120 provides a manual contact point (e.g., for manually closing the door), enhancing usability; and the fixing seat 130 ensures firm installation to the door body, collectively improving the component's functionality, usability, and assembly stability.

In this embodiment, the first elastic component 230 is a torsion spring. This choice leverages the torsion spring's ability to provide rotational elastic force, supplying stable and reliable torque for the rotation and reset of the buckling component 221 and the control component 222. It ensures precise and smooth switching actions of the lock catch assembly 200 between the fastening state and the releasing state, while its compact structure is well-suited for the primarily rotational internal mechanism in the door lock.

In this embodiment, the lock catch assembly 200 further includes a control button 240. The outer housing 211 is provided with a button mounting hole 2111b. The control button 240 passes through the button mounting hole 2111b from the inner side 11 of the accommodating space 213 and is movably connected to the outer housing 211. One end of the control button 240 inside the accommodating space 213 abuts against the triggering portion 2223. The control button 240 provides users with a manual method for triggering the release of the lock catch assembly 200 from the door's inner side 11, enhancing convenience and safety, and achieving integrated dual control from both sides of the door.

In this embodiment, the control button 240 is provided with a guiding rib 241, and the outer housing 211 is defined with a guiding groove 2111a. The control button 240 is slidably connected to the outer housing 211 via the guiding groove 2111a and the guiding rib 241. This sliding fit ensures smooth linear motion of the control button 240 within the outer housing 211, effectively preventing deviation or jamming during pressing, thereby improving operational smoothness, tactile consistency, and component durability.

In this embodiment, a pressing portion of the control button 240 that protrudes from the outer housing 211 is hemispherical. This ergonomic design enhances pressing comfort and, more importantly, the hemispherical protrusion makes it difficult for external individuals to exert force or pry it open with tools, thereby significantly increasing resistance to unauthorized access and improving the anti-tampering and anti-theft performance of the door lock.

In this embodiment, the outer housing 211 is made of zinc alloy. The selection of zinc alloy capitalizes on its excellent corrosion and rust resistance, effectively protecting against moisture in the air and corrosive substances in daily use. This ensures the long-term integrity of the appearance and reliability of the internal structure of the lock catch assembly 200 in harsh environments such as high humidity, greatly extending product lifespan. Additionally, the high strength, hardness, and superior casting performance of zinc alloy provide robust external protection for the lock catch assembly 200, effectively resisting external impacts and prying attempts, thereby enhancing the security and overall durability of the product. Its good processability also facilitates the manufacturing of complex outer housing structures.

In this embodiment, the outer housing 211 is fixedly connected to the inner side 11 of the door 10 by a threaded fastener. This configuration ensures secure and stable installation of the lock catch assembly 200, effectively preventing loosening caused by vibrations or impacts during use. Moreover, this standardized connection method allows for easy disassembly, facilitating future maintenance and replacement.

The above description presents one or more embodiments based on specific implementation details and should not be interpreted as limiting the disclosure exclusively to these examples. Any methods or structures that are similar or approximate, or any technical variations or substitutions made under the conceptual framework of this disclosure, shall be regarded as within the scope of protection of the present disclosure.

What is claimed is:

1. A door lock, configured to lock or open a door, the door comprises an inner side, an outer side, and a mounting through hole passing through the inner side and the outer side, wherein the door lock comprising:
a lock bolt, which is fixedly connected to the inner side of the door, and the lock bolt is configured to rotate with a rotation of the door; and
a lock catch assembly, which is fixedly connected to the inner side of the door, and the lock catch assembly comprises a fastening state and a releasing state; when the door is in a closed state, the lock catch assembly is in the fastening state, and the lock bolt is fastened by the lock catch assembly; and
a switching control assembly, which is fixedly connected to the outer side of the door; when the door is in the closed state, the switching control assembly is configured for switching the lock catch assembly from the fastening state to the releasing state, and during a process of switching the lock catch assembly from the fastening state to the releasing state, the lock bolt automatically pops out of the lock catch assembly and drives the door to rotate to disengage from the closed state; the switching control assembly comprises an unlocking state set to operable and a locking state that set to prohibit operation;
a combination lock assembly, which is configure to control the switching control assembly to switch between the unlocking state and the locking state.

2. The door lock according to claim 1, wherein the switching control assembly comprises a flexible traction component, a mounting base, an operating component, and a mounting housing;
wherein the operating component is movably connected to the mounting housing, the mounting base is fixedly connected to the outer side of the door, and the mounting housing is movably connected to the mounting base;
the operating component is configured to pull the flexible traction component and the lock catch assembly is driven by the flexible traction component, eventually leading the lock catch assembly is switched from the fastening state to a releasing state.

3. The door lock according to claim 2, wherein the operating component is slidably connected to the mounting housing, the operating component is configured to slide relative to the operating component, leading the lock catch assembly switch from the fastening state to the releasing state.

4. The door lock according to claim 3, wherein the operating component is equipped with a first sliding connection portion, and the mounting housing is equipped with a second sliding connection portion; the operating component and the mounting housing are slidably connected through the first sliding connection portion and the second sliding connection portion.

5. The door lock according to claim 1, wherein the lock catch assembly comprises a fixing component, an active component, and a first elastic component;
wherein the fixing component is fixedly connected to the inner side of the door, the active component is rotatably connected to the fixing component, and the active component comprises the fastening state and the releasing state;
during a process of the active component switching from the fastening state to the releasing state, the first elastic component applies an elastic force to the lock bolt through the active component, causing the lock bolt to automatically pop out of the lock catch assembly, thereby driving the door to rotate and disengage from the closed state.

6. The door lock according to claim 5, wherein the fixing component comprises an outer housing and an inner housing; wherein the outer housing is fixedly connected to the inner side of the door, and the outer housing is defined with an accommodating space; the inner housing is placed in the accommodating space, and the active component is rotatably connected to the inner housing.

7. The door lock according to claim 6, wherein the inner housing is provided a first installing shaft and a second installing shaft; the active component comprises a buckling component and a control component;
wherein the buckling component is rotatably connected to the first installing shaft, and the control component is rotatably connected to the second installing shaft; the first elastic component is abutted on the buckling component and the control component, leading the buckling component and the control component abut each other without external force.

8. The door lock according to claim 7, wherein the buckling component comprises a first preload abutting portion and a first abutting portion, and the control component comprises a second preload abutting portion and a second abutting portion;
wherein the first elastic component is abutted on the first preload abutting portion and the second preload abutting portion, the first elastic component is configured to apply an elastic pre-tightening force to the first preload abutting portion and the second preload abutting portion, to lead the first abutting portion and the second abutting portion abut each other without external force.

9. The door lock according to claim 8, wherein the buckling component further comprises a locking portion, and the inner housing further comprises a matching portion;
wherein the first abutting portion comprises a first fastening position, a second fastening position, and an unlocking position;
when the first abutting portion and the second abutting portion respectively abut at the first fastening position and the second fastening position, the matching portion engages with the locking portion, thereby fastening the lock bolt between the matching portion and the locking portion, making the lock catch assembly in the fastening state□
when the first abutting portion and the second abutting portion abut at the unlocking position, the matching portion and the locking portion disengage, causing the lock bolt to automatically pop out from between the matching portion and the locking portion, thereby making the lock catch assembly in the releasing state.

10. The door lock according to claim 9, wherein the buckling component is provided with a third abutting portion, and the control component is provided with a triggering portion, the inner housing is provided with a limiting portion;
when the triggering portion is subjected to an external force, the control component overcomes the elastic pre-tightening force provided by the first elastic component and rotates until it disengages from the first abutting portion, leading the limiting portion to contact the third abutting portion, and the lock catch assembly is in the releasing state;
if the external force is removed at this point, the first abutting portion and the second abutting portion remain in contact at the unlocking position under a driving force of the elastic pre-tightening force.

11. The door lock according to claim 10, wherein the switching control assembly comprises a flexible traction component, a mounting base, an operating component and a mounting housing;
wherein the operating component is actively connected to the mounting base, and the mounting base is fixedly connected to the outer side of the door, and the mounting housing is actively connected to the mounting base;
the triggering portion is defined with a connecting through hole; the flexible traction component comprises a first connecting end and a second connecting end; the second connecting end is connected to the triggering portion via the connecting through hole, and the first connecting end is passed through the mounting through hole and connected to the operating component;
the flexible traction component and the triggering portion are pulled by the operating component, thereby driving the control component to overcome the elastic pre-tightening force provided by the first elastic component and rotate until it disengages from the first abutting portion, and ultimately switches the lock catch assembly from the fastening state to the releasing state;
during the process of switching the lock catch assembly from the fastening state to the releasing state, the matching portion disengages from the locking portion, and the lock bolt automatically pops out from between the matching portion and the locking portion, driving the door to rotate and disengage from the closed state.

12. The door lock according to claim 11, wherein the combination lock assembly comprises a locking frame, and the locking frame is configured to selectively restrict a movement of the operating component, leading the operating component to switch between the unlocking state and the and the locking state of the switching control assembly.

13. The door lock according to claim 12, wherein the locking frame is equipped with a locking block, and the operating component is equipped with an operating portion that cooperates with the locking block; when the locking block engages with the operating portion, the operating component is in the locking state; when the locking block separates from the operating portion, the operating component is in the unlocking state.

14. The door lock according to claim 13, wherein the combination lock assembly further comprises a password component, which is operatively coupled with the locking frame and is configured to allow and actuate a movement of the locking frame upon receiving a correct password input, thus separating the locking block from the operating portion.

15. The door lock according to claim 3, wherein the operating component further comprises an extending portion, which is configured to facilitate user operation.

16. The door lock according to claim 1, wherein the lock bolt comprises a locking rod, a handle, and a fixing seat.

17. The door lock according to claim 5, wherein the first elastic component is a torsion spring.

18. The door lock according to claim 10, wherein the lock catch assembly further comprises a control button, the outer housing is provided with a button mounting hole, and the control button is movably connected to the housing by passing through the button mounting hole from an inner side of the accommodating space, with one end of the control button abutting against the triggering portion inside the accommodating space.

19. The door lock according to claim 10, wherein the control button is provided with a guiding rib, and the outer housing is defined with a guiding groove, the control button is slidably connected to the outer housing through the guiding groove and the guiding rib.

20. The door lock according to claim 18, wherein a pressing portion of the control button protruding from the housing is hemispherical.
